(19) United States
(12) Patent Application Publication
(10) Pub. No.: US 2010/0102256 A1
(43) Pub. Date: Apr. 29, 2010

(54) Surface plasmon device

(75) Inventors: Piers Andrew, Cambridge (GB); Hongwei Li, Cambridge (GB); Markku Oksanen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/290,230

(22) Filed: Oct. 27, 2008

(51) Int. Cl. G21K 1/00; G01N 21/55

(52) U.S. Cl. 250/505.1; 356/445

(57) ABSTRACT

A device comprising first and second antennas and a waveguide configured to guide surface plasmons between the first and second antennas.

### FIELD OF THE INVENTION

The present invention relates to a surface plasmon device.

### BACKGROUND

Radiation found in the terahertz region of the electromagnetic spectrum (herein referred to as “terahertz radiation”) and other regions of the spectrum can be used in many applications including imaging, sensing and spectroscopy.

### SUMMARY

According to some aspects of certain embodiments of the present invention there is provided a device comprising first and second antennas and a waveguide configured to guide surface plasmons between the first and second antennas.

Thus, the device can be used as a sensor for surface plasmon spectroscopy.

The waveguide may be configured to guide surface plasmons from antenna to antenna, e.g. from the first antenna to the second antenna and/or from the second antenna to the first antenna.

The first and second antennas may be configured to receive and/or transmit electromagnetic radiation having different polarizations.

This can be used to help distinguish a return signal transmitted by the sensor from an input signal.

The polarizations may be orthogonal. For example, one antenna may be configured to receive and/or transmit electromagnetic radiation which is linearly polarized at +45° and the other antenna may be configured to receive and/or transmit electromagnetic radiation which is linearly polarized at −45°. The first and second antennas may be elongated and have respective longitudinal axes which are different.

The waveguide may comprise at least one plasmonic resonator, for example, between three and ten plasmonic resonators. The device may be configured to operate at a given wavelength, λ, and the at least one plasmonic resonator may have a diameter, d, of about 0.1λ to about 0.5λ. The at least one plasmonic resonator may have a diameter, d, of about 10 μm to about 500 μm. The device may comprise at least two plasmonic resonators each having a diameter, d, wherein neighbouring plasmonic resonators are separated by about 0.2 d to about 0.5 d.

The waveguide may comprise a channel waveguide.

The device may be configured to operate at a given wavelength, λ, and the waveguide may have a length, l, of the order of λ (i.e. up to 10λ) or of the order of 10λ (i.e. up to 100λ) or more. The device may be configured to operate at a given wavelength, λ, and the waveguide has a width, w, of the order of 0.1λ.

The waveguide may comprise a layer of conductive material, such as a metal or a semiconductor doped with an impurity to at least about 1×10¹⁸ cm⁻³.

The waveguide may be chemically functionalised. Thus, the electromagnetic transmission property of the waveguide can be modulated by exposure to a desired chemical analyte.

The waveguide may comprise an interferometer including first and second paths, wherein the first path, but not the second path, is configured to be exposed to a sample. The waveguide may comprise an interferometer including first and second paths, wherein the first path, but not the second path, is functionalised.

The antennas, e.g. the dimensions of the antennas, may be configured to receive and/or transmit terahertz, infrared and/or visible electromagnetic radiation.

The antennas may be bowtie antennas.

According to certain aspects of some embodiments of the present invention there is provided a source of electromagnetic radiation, the sensor and a detector of electromagnetic radiation, wherein the source is configured to supply the electromagnetic radiation to the device and the detector is configured to detect electromagnetic radiation emitted by the sensor.

The source may be configured to supply terahertz electromagnetic radiation and the detector may be configured to detect terahertz electromagnetic radiation. The source may be configured to supply infrared electromagnetic radiation and the detector may be configured to detect infrared electromagnetic radiation. The source may be configured to supply visible electromagnetic radiation and the detector may be configured to detect visible electromagnetic radiation. The source may be configured to supply linearly-polarized electromagnetic radiation of a given polarization and the detector may be configured to detect linearly-polarized electromagnetic radiation of a polarization which is substantially orthogonal to the given polarization. The source may be configured to supply a continuous wave of electromagnetic radiation and/or pulses of electromagnetic radiation. The source pulses of electromagnetic radiation to sweep the frequency of electromagnetic radiation.

According to some aspects of certain embodiments of the present invention there is provided a method comprising providing a device comprising first and second antennas and a waveguide configured to guide surface plasmons between the first and second antennas. The method may further comprise supplying electromagnetic radiation to a device and detecting electromagnetic radiation emitted by the device.

The method may comprise supplying terahertz electromagnetic radiation to the device. The method may comprise supplying infrared electromagnetic radiation to the device. The method may comprise supplying visible electromagnetic radiation to the device. The method may comprise supplying linearly-polarized electromagnetic radiation of a given polarization to the device and detecting linearly-polarized electromagnetic radiation of a polarization which is substantially orthogonal to the given polarization. The method may comprise supplying continuous wave electromagnetic radiation to the device.

According to certain aspects of the some embodiment of the present invention there is provided means for receiving electromagnetic radiation, means for transmitting electromagnetic radiation and means for guiding surface plasmons between the receiving means and transmitting means.

The means for receiving electromagnetic radiation may be configured to receive linearly-polarized electromagnetic radiation of a given polarization and said means for transmitting electromagnetic radiation may be configured to emit linearly-polarized electromagnetic radiation of a polarization which is substantially orthogonal to the given polarization.

According to some aspects of certain embodiments of the present invention there is provided a device comprising first and second antennas and a waveguide configured to guide surface plasmons from antenna to antenna, e.g. from the first antenna to the second antenna and/or from the second antenna to the first antenna.

### BRIEF DESCRIPTION OF THE DRAWINGS

Certain embodiments of the present invention will now be described, by way of example, with reference to the accompanying drawings in which:

FIG. 1 is a plan view of a first sensor according to some embodiments of the present invention;

FIG. 2 is a cross sectional view of the first sensor shown in FIG. 1 taken along a line A-A′;

FIG. 3 is a cross sectional view of the first sensor shown in FIG. 1 taken along a line B-B′;

FIG. 4 is a plan view of another waveguide structure;

FIG. 4a is a cross section of the waveguide structure shown in FIG. 4 taken along the lines C-C′

FIG. 5 is a plan view of yet another waveguide structure;

FIG. 5a is a cross section of the waveguide structure shown in FIG. 5 taken along the lines D-D′;

FIGS. 6a and 6b illustrate cross sections of layer structures which can be used to form the waveguides shown in FIGS. 4 or 5;

FIG. 7 is a cross section of a waveguide which is chemically functionalized;

FIG. 8 is a plan view of a second sensor according to certain embodiments of the present invention;

FIG. 9 is a cross section of the second sensor shown in FIG. 8 taken along a line E-E′;

FIG. 10 is a cross section of the waveguide shown in FIG. 9 which is chemically functionalized;

FIG. 11 is a plan view of waveguide arranged as an interferometer;

FIG. 12 illustrates apparatus for performing spectroscopy including a sensor;

FIG. 13 is a plan view of the first sensor illustrating irradiation by electromagnetic radiation;

FIG. 14 is a side view of the first sensor illustrating irradiation by electromagnetic radiation;

FIG. 15 illustrates operation of the first sensor shown in FIG. 1;

FIG. 16 is a plan view of a plasmonic resonator;

FIG. 17 is a side view of the plasmonic resonator;

FIG. 18 is a side view of the first sensor illustrating re-radiation of electromagnetic radiation;

FIGS. 19a to 19i illustrates steps during fabrication of the first sensor;

FIG. 20 is a plan view of a third sensor according to some embodiments of the present invention;

FIG. 21 is cross section of waveguide of the third sensor shown in FIG. 20 taken along the line G-G′;

FIG. 22 is cross section of the waveguide shown in FIG. 21 which has been functionalized;

FIG. 23 is a plan view of the third sensor illustrating irradiation by electromagnetic radiation;

FIG. 24 is a side view of the third sensor illustrating irradiation by electromagnetic radiation;

FIG. 25 is a side view of the third sensor illustrating re-radiation of a pulse of electromagnetic radiation;

FIG. 26 illustrates operation of the third sensor;

FIG. 27 is a more detailed plan view of the waveguide; and

FIGS. 28a to 28m illustrates steps during fabrication of the second or third sensor.

### DETAILED DESCRIPTION

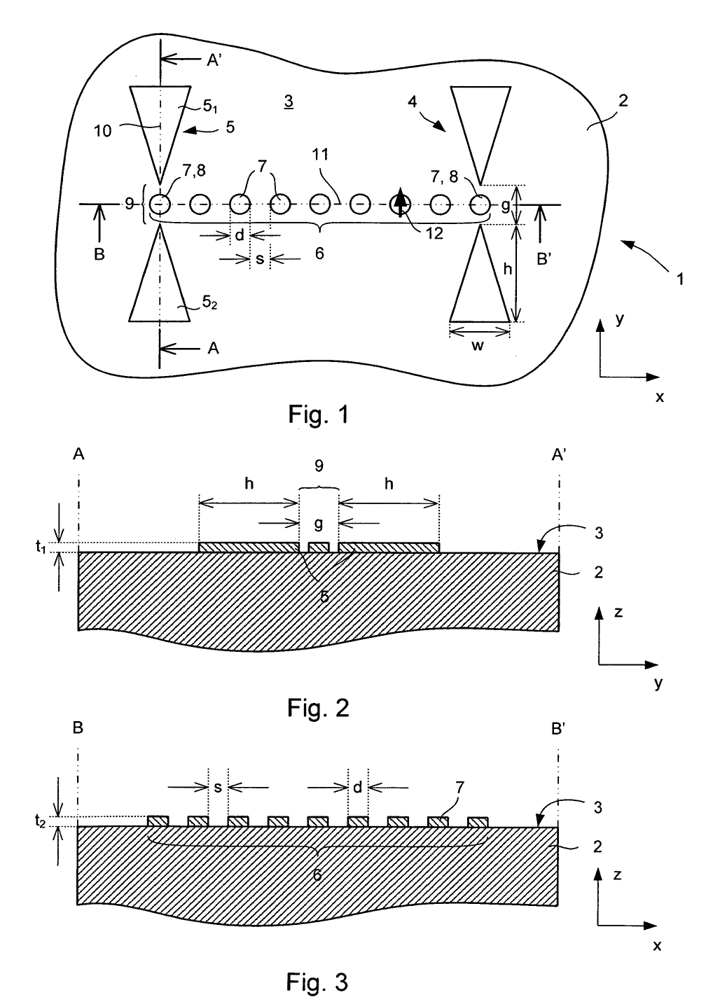

Referring to FIGS. 1 to 3, a first sensing device 1, e.g. for use in surface plasmon spectroscopy, is shown. Hereinafter, the device 1 is referred to as a “sensor”.

The sensor 1 includes a substrate 2 having a surface 3 (e.g. upper or top surface) which supports first and second planar antennas 4, 5 and a waveguide 6 disposed between the antennas 4, 5.

The substrate 2 is formed of a dielectric material, such as silica, sapphire or (e.g. flexible) polymer. However, the substrate 2 may be formed of, or may include a surface or buried layer of, a semiconductor material, such as silicon (Si) or gallium arsenide (GaAs).

In this example, the waveguide 6 includes a particle or surface plasmon resonator 7 (also referred to as a “plasmonic resonator”) or an array, e.g. a single row, of plasmonic resonators 7. There may be between three and ten resonators 7, e.g. about five, in the array. In a resonator array, each resonator 7 is electromagnetically coupled to adjacent neighbouring resonator(s) 7.

For circular (or spherical) resonators, the resonators 7 are electromagnetically coupled through near-field dipolar electromagnetic (or “dipole-dipole”) interaction. The waveguide 6 is electromagnetically coupled to the antennas 4, 5, for example via terminal resonators 8 at the ends of the waveguide 6. However, the waveguide 6 may be connected directly (e.g. resistively) to the antennas 4, 5.

The antennas 4, 5 and waveguide 6 are formed from a thin layer or film of highly conductive material, such as a metal, e.g. aluminium (Al), gold (Au) or copper (Cu), plural layers of metals, an alloy including at least two different metals, or a highly-doped semiconductor (e.g. doped with donors or acceptors to a concentration of about 1×10¹⁸ cm⁻³ or greater, about 1×10¹⁹ cm⁻³ or greater, or even about 1×10²⁰ cm⁻³ or greater, e.g. up to a solubility or auto-compensation limit), such as silicon or gallium arsenide. The antennas 4, 5 and waveguide 6 are formed from the same material(s), although they can be formed from different materials.

The sensor 1 is configured, e.g. by virtue of the dimensions of the antennas 4, 5 and waveguide 6, to operate at a frequency in the visible, infrared or terahertz regions of the electromagnetic spectrum, i.e. at a wavelength, λ, of the order of 100 nm (i.e. up to 1 μm) to the order of 1 mm. For example, the sensor 1 may operate at a terahertz frequency, e.g. at wavelengths in the range of about 10 μm to about 1 mm.

Referring in particular to FIGS. 1 and 2, each antenna 4, 5 takes the form of bowtie antenna and comprises two triangular portions 5₁, 5₂ inverted with respect to one another and separated by an antenna gap 9 having a width, g. Each triangular portion 5₁, 5₂ has a height, h, of, e.g. about 0.1λ to about 0.2λ and a width, w, of about 0.5 h to about 1.2 h. The gap, g, can take a value between about 0.1 h and about 2 h. The antennas 4, 5 have a thickness (i.e. film thickness), t₁, of about 200 nm to about 1 μm.

For a sensor configured for use at a terahertz frequency, e.g. in the range of about 0.3 THz to about 3 THz (which corresponds to a wavelength, λ, of about 1 mm to about 100 μm), the triangular portions 5₁, 5₂ can have a height, h, from about 200 μm (for λ≈1 mm and h≈0.2λ) to about 10 μm (for λ≈100 μm and h≈0.1λ). Thus, the width, w, can take values from about 240 μm (for h≈200 μm and w≈1.2 h) to about 5 μm (for h≈10 μm and w≈0.5 h). The antenna gap, g, can take values of about 400 μm (for h≈200 μm and g≈2 h) to about 1 μm (for h≈100 μm and g≈0.1 h).

The antennas 4, 5 are generally elongated having a longitudinal axis 10. In this example, the antennas 4, 5 are aligned in parallel, i.e. the longitudinal axes 10 of the respective antennas 4, 5 are parallel. However, as will be explained hereinafter, the longitudinal axes of the respective antennas need not be parallel and may, for example, be perpendicular.

Other forms of antenna capable of receiving (or transmitting) radiation over a wide angle, e.g. of the order of 10° (up to 90°), can be used. An antenna capable of (or transmitting) radiation over a wide angle can help allow the sensor to be remotely interrogated over a wide angle range. However, antennas capable of receiving (or transmitting) radiation over a narrow angle, e.g. less than about 10°, can be used. Antennas having a preferred polarization may be used, such as a dipole antenna. The antenna may be planar. Planar antennas, such as the bowtie antennas 4, 5 illustrated in FIG. 1, can be easier to fabricate, for example because they can be printed or defined in a single lithographic step. However, non-planar antennas may be used.

As will be explained in more detail later, the antennas 4, 5 and the resonators 7 are arranged so that the dipoles of the resonators 7 are aligned in parallel. The dipoles are also aligned to the long-axis of the gap between the antenna portions 5₁, 5₂. However, they need not be so aligned, for example, if polarization can be rotated during propagation along the waveguide 6.

The antennas 4, 5 are configured to receive (or “collect”) electromagnetic radiation in the visible, infrared or terahertz regions of the electromagnetic spectrum (e.g. at a frequency in the range of about 0.1 THz to about 1000 THz) and to induce a highly-localized and enhanced electromagnetic field in the gap and excite surface plasmons in the waveguide 6. The waveguide 6 guides surface plasmons from antenna to antenna.

The shape of each antenna 4, 5 and its position with respect to the waveguide 6 may be arranged to help to maximise excitation of mode(s) in the waveguide 6.

Referring in particular to FIGS. 1 and 3, the resonators 7 take the form of nanometre- or micrometre-sized planar disks of highly conductive material.

However, the resonators 7 can have other shapes, such as polygons or ellipses. Alternatively, the resonators 7 can be irregularly shaped. The use of non-circular may result in excitation of higher-order multipoles which can alter propagation of energy along the guide 6 and can result in localized regions of high field intensity. This can increase sensitivity of the device.

The waveguide 6 has thickness, t₂, of about 200 to about 1 μm, and in this example is the same thickness as the antennas 4, 5, i.e. t₁=t₂.

The resonators 7 have a diameter, d, of about 0.1λ to about 0.5λ, and are separated from adjacent neighbouring resonators 7 by a distance, s, of about 0.2 d to 0.5 d. The resonators 7 are arranged in line along a longitudinal axis 11 which is transverse, e.g. perpendicular, to the longitudinal axes 10 of the antennas 4, 5.

For a sensor configured for use at a terahertz frequency, e.g. in the range of about 0.3 THz to about 3 THz, then the resonators 7 have a diameter of about 500 μm (for λ≈1 mm and d≈0.5λ) to about 10 μm (for λ≈100 μm and d≈0.1λ). The diameter, d, of the resonators 7 may be limited by the antenna gap, g, i.e. d<g. The separation, s, can take values from about 250 μm (for d≈500 μm and s≈0.5 d) to about 2 μm (for d≈10 μm and s≈0.2 d).

The waveguide 6 need not be linear. For example, the waveguide 6 may include turns or bend(s) or include linked curved bends (sometimes referred to as being “serpentine”).

As shown in FIG. 1, the antennas 4, 5 and the waveguide 6 are arranged so that, when excited, plasmons exhibit lateral or “in-plane” polarization 12 which is parallel to the direction of antenna gap 9 (as opposed to a polarization which is orthogonal to the direction of the gap 9, e.g. orientated vertically, i.e. into the surface 3 of the substrate 2).

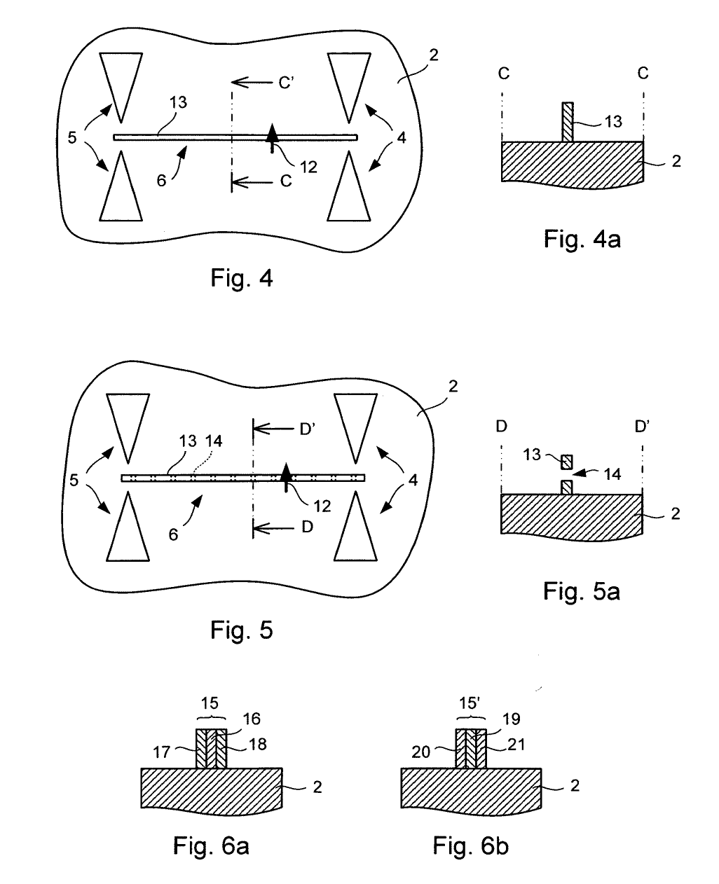

Referring to FIGS. 4 and 5, the waveguide 6 can take other forms and need not include resonators 7 (FIG. 1).

FIGS. 4 and 4a shows a sensor which is the same as the sensor 1 shown in FIG. 1 except that it has a waveguide 6 comprising an elongate upstanding strip 13 (or “rib” or “fin”) formed of, for example, a layer of highly conductive material, such as a metal or highly-doped semiconductor. In the arrangement shown in FIGS. 4 and 4a, the antennas 4, 5 and the waveguide 6 are arranged so that plasmons exhibit a in-plane polarization 12.

FIGS. 5 and 5a show a sensor which is the same as the sensor 1 shown in FIG. 1 except that it has a waveguide 6 in the form of an elongate rib or elongate fin 13 of highly conductive material having an array of holes 14 through the rib 13 which run transverse the longitudinal axis of the rib, spaced along length of the fin. Thus, the waveguide 6 may provide a “plasmonic crystal” which modifies propagation of surface plasmons along the waveguide in a similar way to the way that a photonic crystal affects propagation of photons.

The waveguide structure shown in FIG. 5 and 5a can be formed by forming a first resist mask having a window defining the elongate waveguide and depositing a layer of conductive material through the mask. The resist may be lifted off in a solvent to form a lower or base portion of the channel. The process continues by forming a second resist mask having thin lines of resist running across the channel defining the holes. Without removing the second resist mask, a third resist mask having the same shaped window is formed aligned with the channel. Another layer of conductive material is deposited to form the upper portion of the channel. The resist layer is lifted off and in doing so also removes the second resist layer thereby leaving voids, i.e. holes, between the lower and upper portions of the channel.

Referring to FIGS. 6a and 6b, the waveguides 6 shown in FIG. 4 and 5 can be formed using layer structures 15, 15′ in which upstanding layers are arranged in a row, side-by-side.

Referring to FIG. 6a, the layer structure 15 may include a layer 16 of dielectric material sandwiched between a pair of highly conductive layers 17, 18. The conductive layers 16, 18 can be formed of the same material and may have the same thickness.

This type of layer structure provides two metal-dielectric interfaces and can help coupled surface plasmons to propagate through the waveguide and can exhibit lower losses compared with a waveguide with a single metal-dielectric interface.

Referring to FIG. 6b, an “inverted” layer structure 15′ may include a layer 19 of highly conductive material sandwiched between a pair of dielectric layers 20, 21. The dielectric layers 20, 21 can be formed of the same material and may have the same thickness. The substrate 2 may be a dielectric or may be conductive.

Likewise, this type of layer structure can exhibit lower losses.

The conductive layers 17, 18, 19 can have a thickness of about 20 nm to about 10 μm, e.g. between about 200 nm to about 1 μm. The dielectric layers 16, 20, 21 can have a thickness of about 20 nm to about 10 μm, e.g. between about 200 nm to about 1 μm.

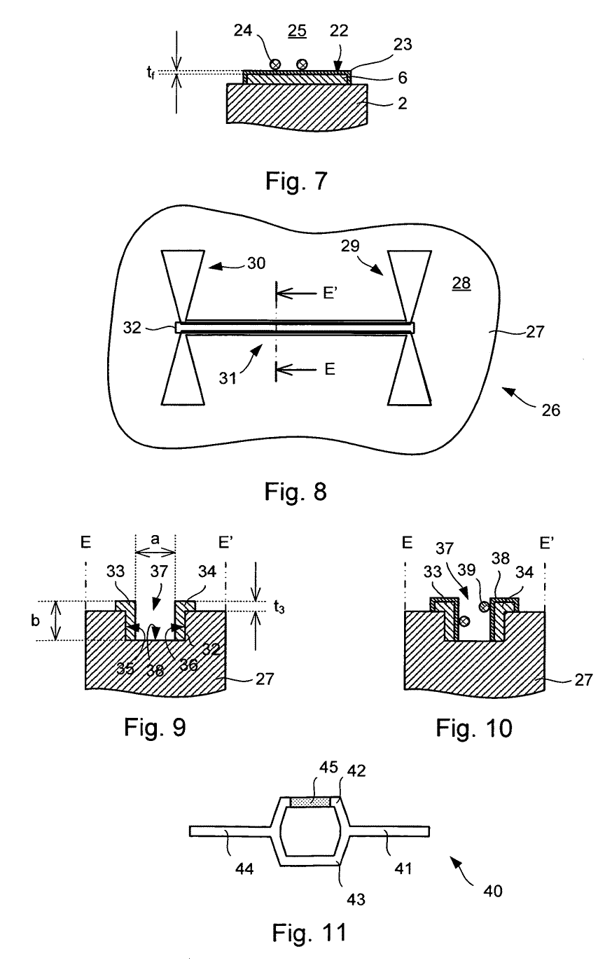

Referring to FIG. 7, an outer surface 22 (e.g. upper and lateral surfaces) of the waveguide 6 may be chemically functionalised with a functional layer 23, for example including thiol- or silane-terminated groups, for helping an analyte 24, such as chemical or biochemical molecule (or part thereof), to bind to the waveguide 6.

The functional layer 23 may have a thickness, t₁, of the order of 0.1λ (i.e. up to λ) or λ (i.e. up to 10λ). Thus, the functional layer 23 can occupy a significant amount or all of a volume into which the electromagnetic field (normal to the metal-dielectric interface) decays into the dielectric medium as an evanescent wave.

The functional layer 23 may comprise one or more than one layer. The functional layer 23 may be porous, e.g. in the form of a hollow matrix or gel, which allows an analyte to penetrate into the layer 23.

Propagation of surface plasmons through the waveguide 6 is sensitive to the condition of the interface between the waveguide 6 and an external medium 25 including the functional layer 23 (if present) and any analytes 24.

In the examples described earlier, the metal/dielectric interfaces affected most by an analyte 24 generally lie across and/or parallel to the surface of the substrate. However, other waveguide configurations may be used.

For example, referring to FIGS. 8 and 9, a second sensor 26 is shown which is similar to the first device 1 (FIG. 1) described earlier.

The sensor 26 includes a substrate 27 having an upper surface 28 which supports first and second antennas 29, 30. The sensor 26 includes a waveguide 31 disposed between the antennas 29, 30. However, the waveguide 31 is formed in an elongate channel or slot 32 etched into the substrate 27.

Referring in particular to FIG. 9, the waveguide 31 comprises a pair of facing strips 33, 34 of highly-conductive material arranged on vertical sidewalls 35, 36 of the channel 32 so as to define an open-topped cavity or core 37 between the strips 33, 34.

The channel 32 can be formed using an anisotropic etch. The strips 33, 34 may be formed by depositing (e.g. by r.f. sputtering) metal through a mask so as to cover the sidewalls 35, 36 but not the middle of the floor 38, of the channel 32. Alternatively, the strips may be formed by deposing metal through the mask so as to line the channel and etching a slot along the middle of the floor of the channel so as to separate the strips. The strips may be formed by successive angled evaporation, i.e. by sequentially depositing metal on the sidewalls by rotating the substrate along the longitudinal axis of the channel to a sufficiently large (but still acute) angle which is off normal with respect to an evaporation source. Thus, the ‘shadow’ cast by the long edge of the channel is used to deposit metal on only one sidewall at a time.

The channel may be formed by imprint lithography and the strips may be printed using conductive ink.

The core 37 has a width, a, of the order of 0.1λ or λ, a height, b, of the order of 0.1λ or λ and a length (not shown) of about λ or 10λ. The strips 33, 34 have a thickness, t₃, of about 200 nm to 1 μm.

For a sensor configured for use at a terahertz frequency, e.g. in the range of about 0.3 THz to about 3 THz, then the core can have a width of the order of 100 μm (for λ≈1 mm) to 10 μm (for λ≈100 μm).

The strips 33, 34 need not be electrically isolated from each other. For example, the highly-conductive material may cover not only the vertical sidewalls 35, 36 of the channel 32, but also the floor 38 of the channel 32.

This type of parallel-strip waveguide need not be formed in an etched slot or channel.

For example, the strips may be formed as a pair of ridges or ribs (not shown) upstanding from a substrate. These can be formed by depositing a thick film of metal (e.g. having a thickness of the order of 1 or 10 μm) and using an anisotropic etch to define the strips and form the core.

Alternatively, the strips may be formed on outer sidewall of a mesa defining a ridge or rib (not shown) of dielectric material.

The core may be filled with a dielectric material, which may be active, i.e. to draw and/or bind to analyte.

As shown in FIG. 10, the waveguide 31 may be coated with a functional layer 38 which can be used to bind an analyte 39. In this arrangement, the analyte 39 may be located in the core 37 and can strongly affect propagation of coupled surface plasmons in the strips 33, 34. The thickness of the functional layer 38 may the same as that hereinbefore described.

In the examples described earlier, the waveguides guide surface plasmons between the antennas along a single path. However, the waveguides may be modified so as to provide multiple and/or a closed-loop path, e.g. to form an interferometer.

Referring to FIG. 11, a waveguide 40 includes a first section 41, which branches into first and second arms 42, 43 which recombine into a second section 44 to form a ring interferometer. The waveguide 40 may comprises a strip of metal. However, any of the waveguide structures, e.g. using resonators, and layer structures described earlier can be used.

As shown in FIG. 11, one of the arms 42 is coated with a functional layer 45 having a given specificity, i.e. binds to a specific analyte. The other arm 43 may be left uncoated without any functional layer or coated with a functional layer which has complementary specificity to the functional layer 45, i.e. does not bind to (or even repels) the specific analyte. Thus, an analyte can preferentially bind to the functional layer 45. Using an interferometer can increase sensitivity of the sensor.

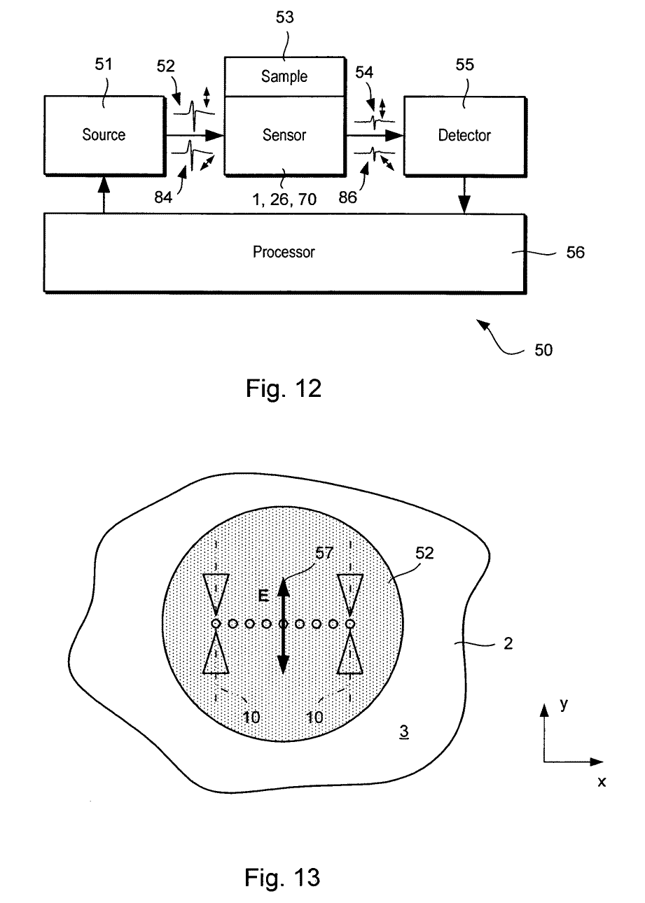

Referring to FIG. 12, apparatus 50 for performing surface plasmon spectroscopy is shown. The apparatus 50 includes a source 51 of, e.g. monochromatic, radiation in a visible, infrared or terahertz region of the electromagnetic spectrum, such as an optically-pumped terahertz laser, a quantum-cascade semiconductor laser or photoconductive pulse source, which provides incident radiation 52, 84 (e.g. at a frequency in a range of about 0.1 to about 1000 THz) to the sensor 1, 26, 70 which is in contact with a sample 53. The sensor 1, 26, 70 generates modified radiation 54, 86 which is received by a detector 55, such as a photoconductive switch. A controller 56, for example in the form of a computer running software stored in memory (not shown), controls the source 51 and detector 55. The source 51, detector 55 and controller 56 may be a spectroscopic system, such as a PB7100 Frequency Domain Terahertz Spectrometer available from Emcore Corporation, Albuquerque, N.Mex., USA.

The apparatus 50 can be used to screen for the presence of a particular analyte or class of analyte. For example, this can be achieved by choosing a functional layer 23 (FIG. 7), 38 (FIG. 10), 45 (FIG. 11), 81 (FIG. 22) which binds to the analyte (or class of analyte), irradiating the sensor 1, 26, 70 with a continuous wave or pulses at a given frequency using the source 51 and monitoring the output signal 54 using the detector 55 to identify changes.

The apparatus 50 can be used as a spectroscopic detector. For example, this may involve choosing a functional layer 23 (FIG. 7), 38 (FIG. 10), 45 (FIG. 11), 81 (FIG. 22) which binds to a wide range of analyte or omitting the function layer, irradiating the sensor 1, 26 with a continuous wave or pulses using the source 51 and sweeping the frequency of the radiation and monitoring the output signal 54 using the detector 55 to identify the appearance of absorption lines. Certain wavelengths will be preferentially absorbed according to the analyte present.

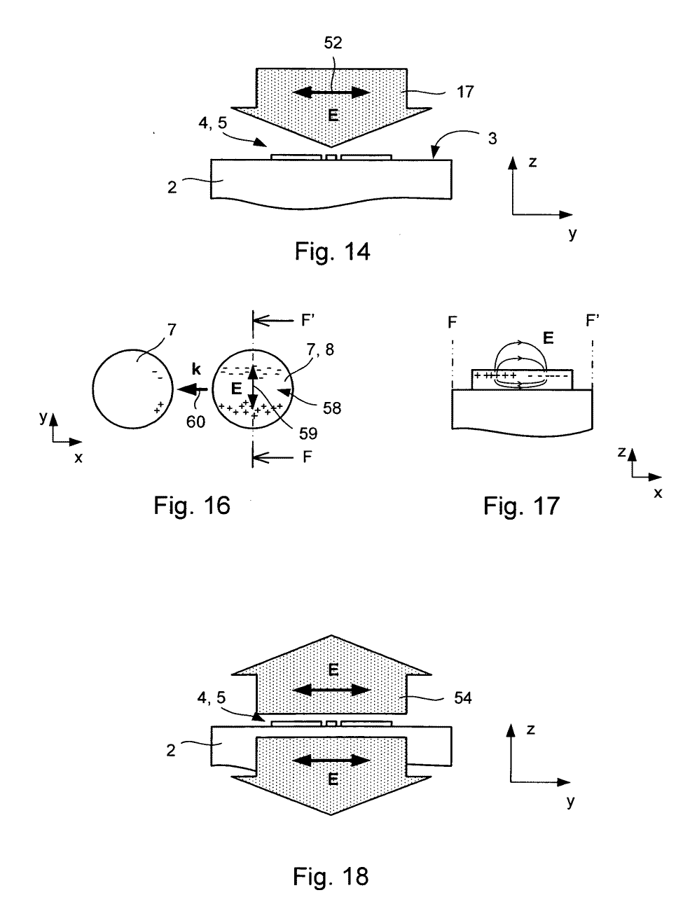

Referring to FIGS. 12 to 18, operation of the sensor 1 will now be described.

Linearly-polarised radiation 52, e.g. in the form a laser beam, is directed substantially perpendicularly to the surface 3 of the substrate 2. However, the radiation need not be substantially perpendicularly to the surface 3. Polarization 57 of the radiation 52 (i.e. the direction of its electric field vector, E) is orientated along the longitudinal axes 10 of the antennas 4, 5 (which in this example are parallel). The incident radiation optically excites surface plasmons in the terminal resonators 8 (step S1).

FIGS. 16 and 17 schematically illustrate charge distribution of a localised surface plasmon 58 (at a moment frozen in time) excited in the resonator 8 and the corresponding dipole 59 and wavevector 60.

The plasmons propagate through the waveguide 6, i.e. passing from one resonator 7 to the next adjacent resonator 7 (steps S2 & S3) and continue to propagate towards the ends of the waveguide 6 (step S4).

Propagation of plasmons is affected by the condition of the interface of the waveguide 6. Thus, the type and the concentration of an analyte such as, for example, water or bacteria, bound to the waveguide 6 affects propagation.

When the plasmons reach the terminal resonators 8, linearly-polarized radiation 19 is re-radiated out of (and into) the substrate 2 (step S5) and is received by detector 55.

The processor 56 can compare a response of the sensor 1 in the absence of a sample 53 with the response of the sensor 1 in the presence of the sample 53 so as to identify, e.g. the presence, identity and/or concentration of analyte (or analytes) present in the sample 18.

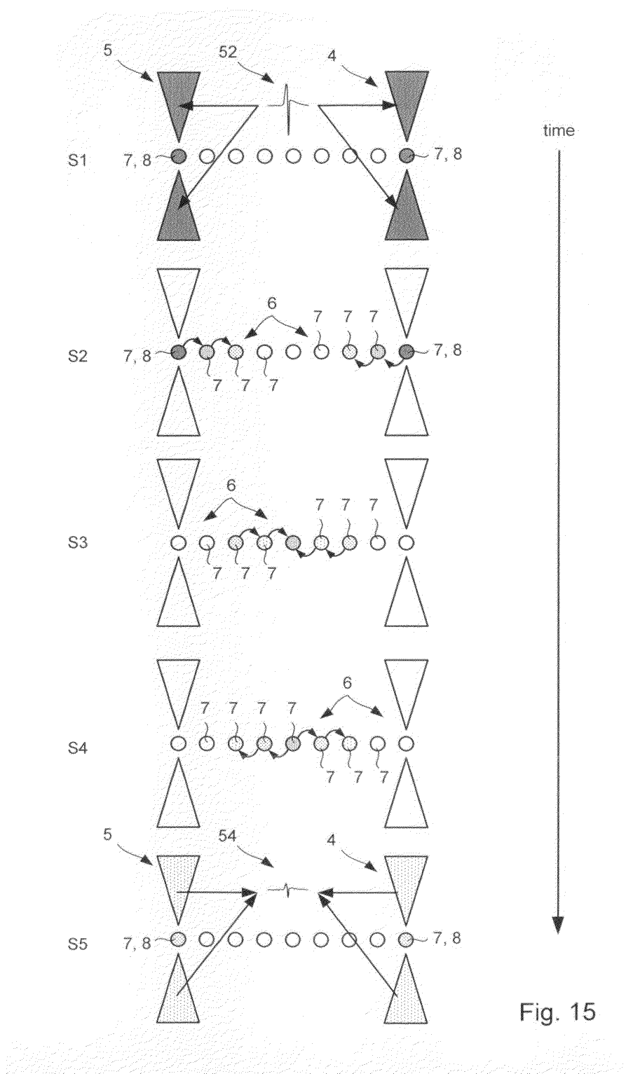

For a continuous wave source, the process shown in FIG. 15 is continuous and ongoing, i.e. incident radiation 52 is continually received by the antennas 4, 5, plasmons 58 are continually generated and propagate through the waveguide 6, and output radiation 54 is continually emitted.

For a pulsed source, the process shown in FIG. 15 is intermittent, i.e. a non-continuous train of surface plasmons is generated at each antenna.

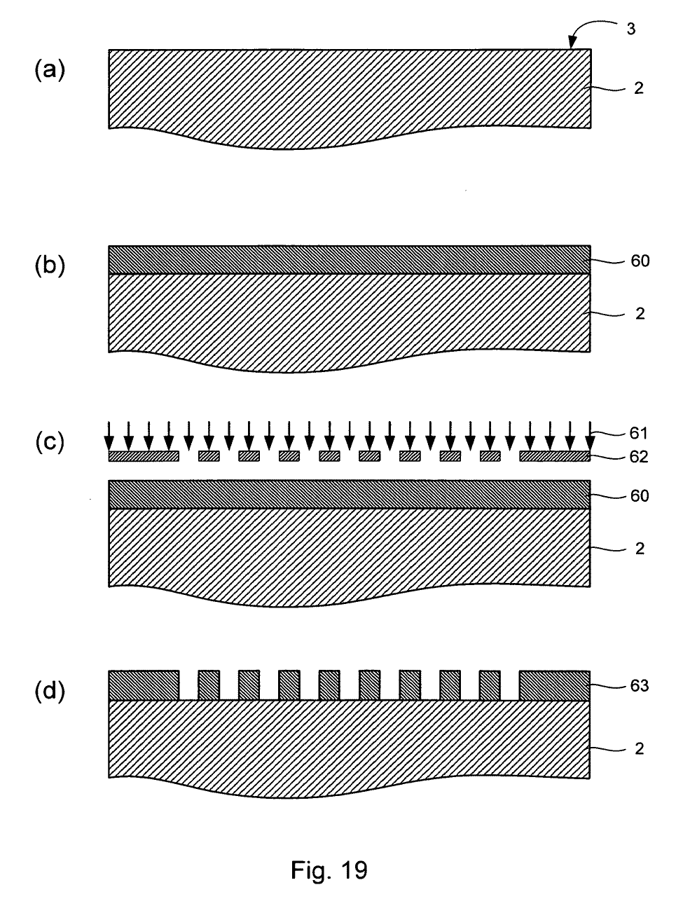

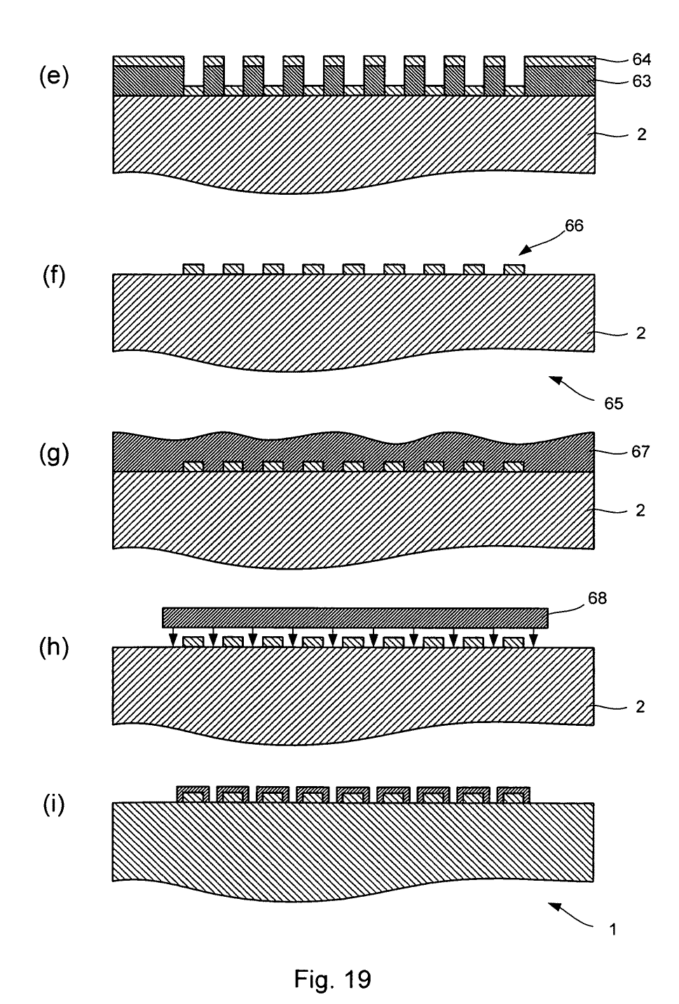

Referring now to FIGS. 19a to 19i, a method of fabricating the sensor 1 will now be described.

As shown in FIG. 19a, a substrate 2 is provided formed of a dielectric or semiconducting material or layers of dielectric and semiconducting material. For example, the substrate 2 may be silicon-on-insulator (SOI).

Photoresist, such as SU-8 (MicroChem Corp., USA) or AZ 5214 (Clariant GmbH, Germany), is applied to the surface 3 of the substrate 2, for example by spin coating, and cured to provide a layer 50 of photoresist, as shown in FIG. 19b.

As shown in FIG. 19c, the photoresist layer 60 is exposed to UV radiation 61 through a mask 62 to define the pattern for the waveguide 6 (FIG. 1) and either antennas 4 (FIG. 1), 5 (FIG. 1).

The exposed photoresist layer 60 is developed to leave a patterned photoresist layer 63, as shown in FIG. 19d.

As shown in FIG. 19e, a thin layer (or layers) 64 of metal is evaporated (e.g. (thermally evaporated or by e-beam evaporation) over the patterned resist layer 63.

Unwanted regions of the metal layer 64 (which overlies the patterned resist layer 63) are lifted off in a solvent to provide a patterned substrate 65 comprising the substrate 2 and a patterned metal layer 66, as shown in FIG. 19f.

As shown in FIG. 19g, the patterned substrate 65 is dipped in a solution 67 of appropriately functionalised thiol in ethanol so as to functionalise the metal layer 37.

Alternatively, as shown in FIG. 19h, a patterned layer 68 of thiol can be applied by printing, e.g. microcontact printing, or, if feature size is large enough, by inkjet, screen or other form of printing.

The completed device 1 is shown in FIG. 19i.

In the examples hereinbefore described, if the sensor is irradiated continuously (i.e. with a continuous wave), then it will absorb and emit radiation simultaneously. Thus, a detector may receive both components.

If the sensor is irradiated intermittently (i.e. using pulses of radiation), then it may be possible to distinguish between incident and re-emitted pulses in the time domain. However, under some conditions the detector may still receive incident and re-emitted radiation at the same time.

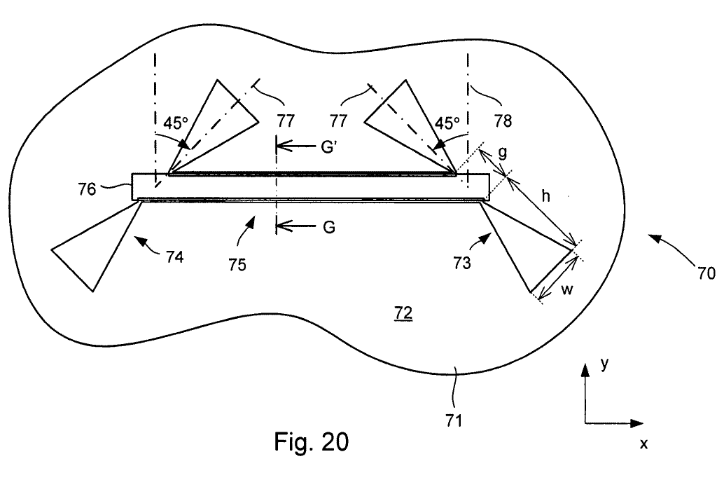

Referring to FIG. 20, a third sensor 70 is shown which can allow a detector to distinguish between and/or isolate incident and re-emitted radiation more easily even if the sensor is irradiated continuously.

The sensor 70 includes a substrate 71 having an upper surface 72 which supports first and second antennas 73, 74. The sensor 70 includes a waveguide 75 disposed between the antennas 73, 74. The width, w, and height, h, of the antennas 73, 74 can be the same as those of the antennas 4, 5 (FIG. 1) described earlier.

The sensor 70 is similar to the second sensor 26 (FIG. 8) in that the waveguide 75 is formed in an elongate channel or slot 76 etched into the substrate 71. However, instead of having antennas which are arranged in parallel, the antennas 73, 74 are “crossed”, i.e. their longitudinal axes 77 are perpendicular. In this case, the antennas 73, 74 are rotated by −45° and +45° respectively with respect to a common axis 78.

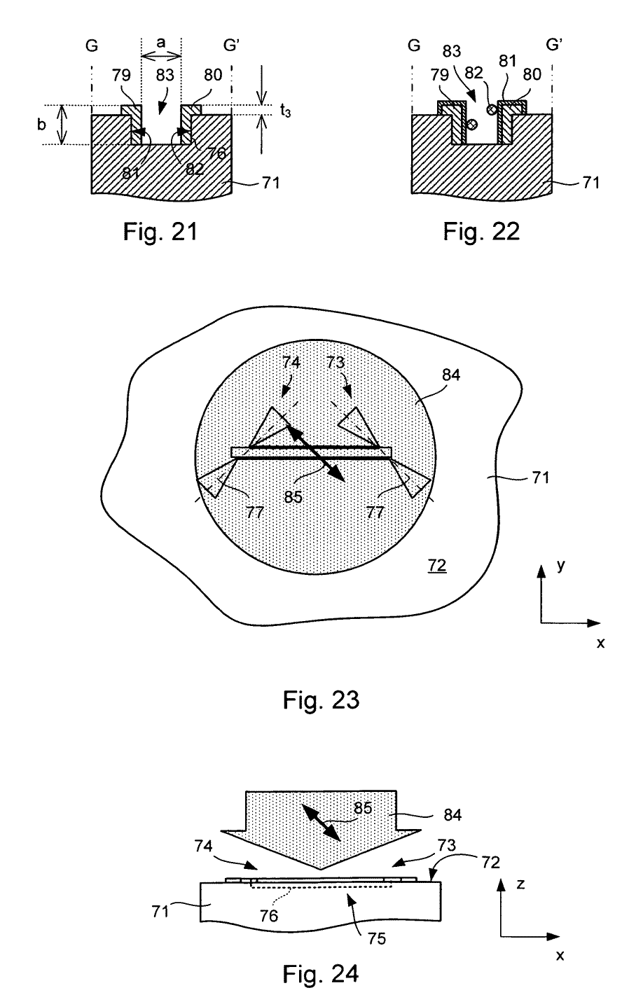

Referring to FIG. 21, the waveguide 75 comprises strips 79, 80 of highly-conductive material arranged on vertical sidewalls 81, 82 of the channel 76 so as to define an open-topped cavity or core 83 between the strips 79, 80.

The core 83 has a width, a, of the order of 0.1λ, a height, b, of the order of 0.1λ and a length (not shown) of the order of λ or 10λ or more. The strips 79, 80 have a thickness, t₃, of about 200 nm to 1 μm.

The length of the waveguide, e.g. waveguide 75, may depend on the decay length of a mode along the waveguide. For example, the greater the decay length, then the longer the waveguide can be. The length of the waveguide may also depend on absorption by a desired analyte on the waveguide. The strong the absorption, then the shorter the waveguide can be.

As shown in FIG. 22, the waveguide 75 may be coated with a functional layer 81 which can be used to bind to an analyte 82. In this arrangement, the analyte 82 can be trapped in the core 83 and so strongly affect propagation of coupled surface plasmons in the waveguide 75. As explained earlier, the functional layer 81 can have a thickness, t_{f}, which is of the order of 0.1λ or λ and can be porous.

Referring also to FIGS. 12, incident radiation 84 can be received and re-emitted radiation 86 can be transmitted by different antennas 73, 74. For example, input radiation 84 having polarization 85 orientated at −45° (i.e. parallel to a longitudinal axis 77 of the first antenna 73) can be received by the first antenna 73 and not by the second antenna 74. Re-emitted radiation 86 having polarization 87 orientated at +45° can be transmitted by the second antenna 74.

Thus, the detector 55 can discriminate between incident and re-emitted radiation 84, 86 by virtue of polarization, e.g. using polarized filters. Herein, this technique of is referred to as “polarization multiplexing”.

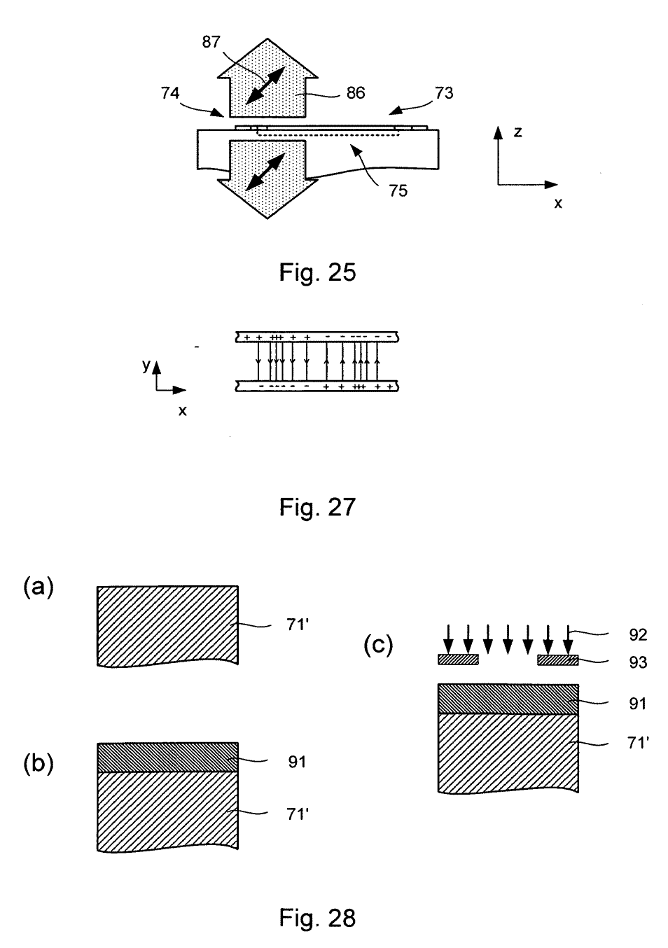

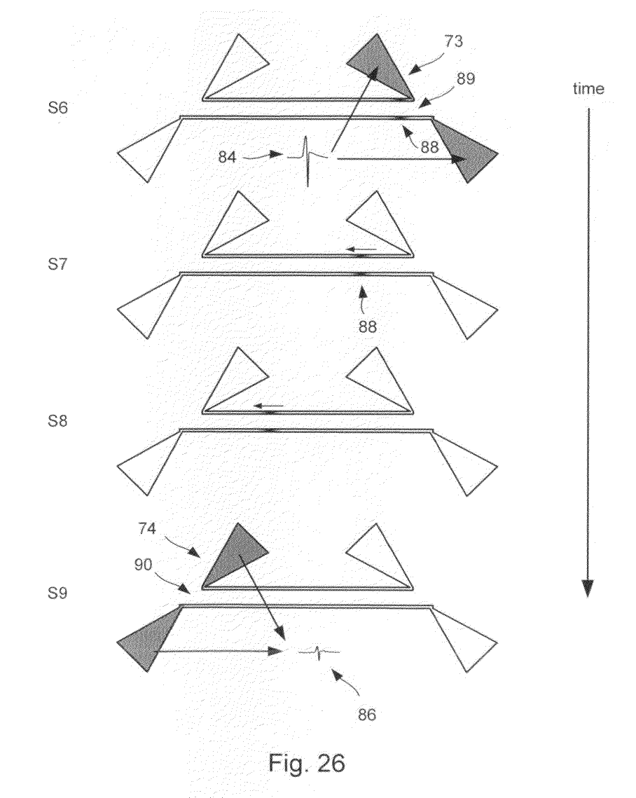

Referring to FIGS. 9 and 20 to 27, operation of the sensor 70 will now be described.

Linearly-polarised radiation 84 (e.g. visible, infrared or terahertz) is directed substantially normally to the surface 72 of the substrate 71. Polarization 85 of the radiation 84 is orientated along the longitudinal axes 77 of the first antenna 73. The incident radiation 84 optically excites surface plasmons 88 at the end 89 of the waveguide 75 (step S6).

Radiation is not coupled into the second antenna 74 because the polarisation of the radiation is orientated perpendicularly to the longitudinal axis 77 of the second antenna 74.

FIG. 27 schematically illustrates charge distribution of a coupled surface plasmon 88 in the waveguide 75.

Plasmons propagate through the waveguide 75 towards the opposite end of the waveguide 6 (steps S7 and S8).

When the plasmons reach the end 90 of the waveguide 75 coupled to the second antenna 75, terahertz radiation 86 is re-radiated (step S9) and is received by detector 55.

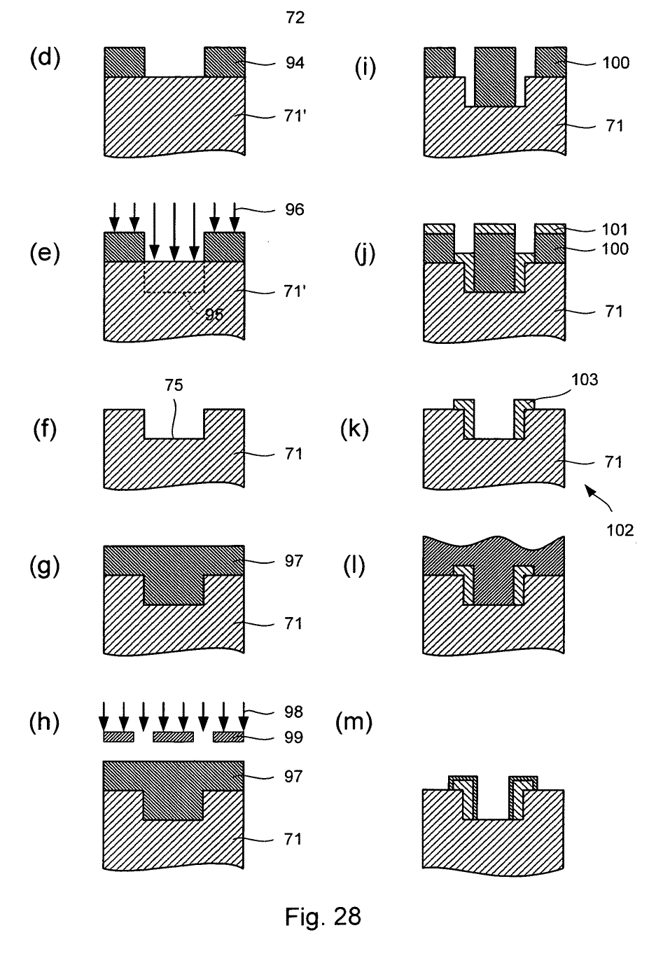

Referring to FIGS. 28a to 28m, a method of fabricating the second sensor 26 (FIG. 8) or the third sensor 70 (FIG. 20) will now be described.

As shown in FIG. 28a, a substrate 71′ is provided formed of a dielectric or semiconducting material or layers of dielectric and semiconducting material. For example, the substrate 71′ may be silicon-on-insulator (SOI).

Photoresist is applied to the surface 72 of the substrate 71′, for example by spin coating, and cured to provide a layer 91 of photoresist, as shown in FIG. 28b.

As shown in FIG. 28c, the photoresist layer 91 is exposed to UV radiation 92 through a mask 93 to define the pattern for the channel 75 (FIG. 20).

The exposed photoresist layer 91 is developed to leave a patterned photoresist layer 94, as shown in FIG. 28d.

As shown in FIG. 28e, a portion 95 of the substrate 71′ is etched, for example, using an anisotropic reactive ion etch 96.

Etching forms the substrate 71 having a channel 75, as shown in FIG. 28f.

If a soft substrate is used, e.g. formed of a polymer, then the channel 75 may be formed using imprint lithography. For example, this may involve pressing a mold into the substrate and curing using heat or UV light.

Another layer of photoresist is applied to the substrate 71 and cured to provide another layer 97 of photoresist, as shown in FIG. 28g.

As shown in FIG. 28h, the photoresist layer 97 is exposed to UV radiation 98 through a mask 99 to define the pattern for antennas 73, 74 (FIG. 20) and strips 79, 80 (FIG. 21).

The exposed photoresist layer 97 is developed to leave a patterned photoresist layer 100, as shown in FIG. 28i.

As shown in FIG. 28j, a thin layer (or layers) 101 of metal is evaporated (e.g. (thermally evaporated or by e-beam evaporation) over the patterned resist layer 100.

Unwanted regions of the metal layer 101 (which overlie the patterned resist layer 100) are lifted off in a solvent to provide a patterned substrate 102 comprising the substrate 71 and a patterned metal layer 103, as shown in FIG. 28k.

Metal can be deposited using an electrochemical deposition process.

As shown in FIG. 28l, the patterned substrate 102 is dipped in a solution 104 of appropriately functionalised thiol in ethanol so as to functionalise the metal layer 103.

Alternatively, a patterned layer (not shown) of thiol can be applied by printing, e.g. microcontact printing, or, if feature size is large enough, by inkjet, screen or other form of printing.

The completed device is shown in FIG. 28m.

The sensors hereinbefore described can be used to detect bacterial contamination and/or monitor water content in, for example, food products and other samples.

It will be appreciated that many modifications may be made to the embodiments hereinbefore described without departing from the spirit and scope of the invention.

The sensors hereinbefore described are optically-pumped using a narrowband source. However, the sensors may be optically-pumped using a wideband source. The sensors may be electrically pumped. The sensors may be provided within an electrical circuit.

In the devices hereinbefore described, surface plasmons propagate laterally along or close to an upper surface of the device. However, the devices may be arranged so that surface plasmons propagate along or close to other orientated surfaces, e.g. vertically along side wall.

The apparatus may be configured to perform time-domain measurements using pulses and obtain gain spectral information by a Fourier transform.

The devices may be fabricated in different ways. For example, electron-beam lithography or x-ray lithography may be used to pattern substrates and define antennas and waveguides. Hard and/or soft masks may be used. Dry and or wet etching may be used.

The devices may be fabricated using printing processes. For example, metal layers can be deposited using “inks” in which metallic or semiconducting material particles are borne in a carrier. The ink can be printed onto a substrate, such as a polymer substrate, and cured using, for example, laser annealing, to form high-quality, highly conductive thin films. Functional layers can be printed over the conductive films. Also, as explained earlier, the substrate may be embossed using imprint lithography to form channel(s). Thus, the devices can be made simply and cheaply.

The device may include more than two antennas, e.g. third and fourth antennas. For example, two antennas may feed into one end of the waveguide. The device may include more than one waveguide, e.g. two waveguides in parallel. For example, one antenna may feed into two waveguides. A complex arrangement may be used, for example, in which multiple antennas feed into multiple waveguides.

We claim:

1. A device comprising:
first and second antennas; and
a waveguide configured to guide surface plasmons between the first and second antennas.

2. The device according to claim 1, wherein the first and second antennas are configured to receive and/or transmit electromagnetic radiation having different polarizations.

3. The device according to claim 1, wherein the polarizations are orthogonal.

4. The device according to claim 3, wherein one antenna is configured to receive and/or transmit electromagnetic radiation which is linearly polarized at +45° and the other antenna is configured to receive and/or transmit electromagnetic radiation which is linearly polarized at −45°.

5. The device according to claim 1, wherein the first and second antennas are elongated and have respective longitudinal axes which are different.

6. The device according to claim 1, wherein the waveguide comprises at least one surface plasmonic resonator.

7. The device according to claim 6, wherein the waveguide comprises between three and ten surface plasmonic resonators.

8. The device according to claim 6, wherein the device is configured to operate at a given wavelength, λ, and the at least one surface plasmonic resonator has a diameter, d, of about 0.1λ to about 0.2λ.

9. The device according to claim 6, wherein the at least one surface plasmonic resonator has a diameter, d, of about 10 μm to about 500 μm.

10. The device according to claim 1, comprising at least two surface plasmonic resonators, each having a diameter, d, wherein adjacent surface plasmonic resonators are separated by about 0.2 d to about 0.5 d.

11. The device according to claim 1, wherein the waveguide comprises a channel waveguide.

12. The device according to claim 1, wherein the device is configured to operate at a given wavelength, λ, and the waveguide has a length, 1, of the order of λ or 10λ.

13. The device according to claim 1, wherein the device is configured to operate at a given wavelength, λ, and the waveguide has a width, w, of the order of 0.1λ or λ.

14. The device according to claim 1, wherein the waveguide comprises a layer of conductive material.

15. The device according to claim 14, wherein the conductive material comprises a metal.

16. The device according to claim 14, wherein the conductive material comprises a semiconductor doped with an impurity to at least about 1×10¹⁸ cm⁻³.

17. The device according to claim 1, wherein the waveguide is chemically functionalised.

18. The device according to claim 1, wherein the waveguide comprises an interferometer including first and second paths, wherein the first path, but not the second path is configured to be exposed to a sample.

19. The device according to claim 1, wherein the waveguide comprises an interferometer including first and second paths, wherein the first path is functionalised.

20. The device according to claim 1, wherein the antennas are configured to receive and/or transmit terahertz electromagnetic radiation.

21. The device according to claim 1, wherein the antennas are configured to receive and/or transmit infrared electromagnetic radiation.

22. The device according to claim 1, wherein the antennas are configured to receive and/or transmit visible electromagnetic radiation.

23. The device according to claim 1, wherein the antennas are bowtie antennas.

24. An apparatus comprising:
a source of electromagnetic radiation;
the device according to claim 1; and
a detector of electromagnetic radiation;
wherein the source is configured to supply the electromagnetic radiation to the device via at least one of the first and second antennas and the detector is configured to detect electromagnetic radiation emitted by at least one of the first and second antennas.

25. The apparatus according to claim 24, wherein the source is configured to supply terahertz electromagnetic radiation and the detector is configured to detect terahertz electromagnetic radiation.

26. The apparatus according to claim 24, wherein the source is configured to supply linearly-polarized electromagnetic radiation of a given polarization and the detector is configured to detect linearly-polarized electromagnetic radiation of a polarization which is substantially orthogonal to the given polarization.

27. The apparatus according to claim 24, wherein the source is configured to supply a continuous wave of electromagnetic radiation.

28. The apparatus according to claim 24, wherein the source is configured to sweep the frequency of electromagnetic radiation.

29. The apparatus according to claim 24, wherein the source is configured to supply pulses of electromagnetic radiation.

30. A method comprising:
providing a device comprising first and second antennas and a waveguide configured to guide surface plasmons between the first and second antennas.

31. A method according to claim 30, further comprising:
supplying electromagnetic radiation to the device; and
detecting electromagnetic radiation emitted by the device.

32. The method according to claim 30, comprising:
supplying terahertz electromagnetic radiation to the device.

33. The method according to claim 30, comprising:
supplying linearly-polarized electromagnetic radiation of a given polarization to the device; and
detecting linearly-polarized electromagnetic radiation of a polarization which is substantially orthogonal to the given polarization.

34. A device comprising:
means for receiving electromagnetic radiation;
means for transmitting electromagnetic radiation; and
means for guiding surface plasmons between the receiving means and transmitting means.

35. The device according to claim 34, wherein:
said means for receiving electromagnetic radiation is configured to receive linearly-polarized electromagnetic radiation of a given polarization and
said means for transmitting electromagnetic radiation is configured to emit linearly-polarized electromagnetic radiation of a polarization which is substantially orthogonal to the given polarization.
